(19) United States
(12) Patent Application Publication
(10) Pub. No.: US 2002/0169755 A1
(43) Pub. Date: Nov. 14, 2002

(54) System and method for the storage, searching, and retrieval of chemical names in a relational database

(76) Inventors: Bomi Patel Framroze, Bombay (IN); Ishtiyaque Ahmed, Mumbai (IN)

Correspondence Address: GOODWIN PROCTER & HOAR LLP, 7 BECKER FARM RD, ROSELAND, NJ, 07068, US

(21) Appl. No.: 09/851,697

(22) Filed: May 9, 2001

(51) Int. Cl. G06F 7/00

(52) U.S. Cl. 707/3

(57) ABSTRACT

A chemical name search system and method are disclosed that allows a user to unambiguously identify a chemical that is included in a database of chemical names quickly and efficiently. The system searches for a chemical name by removing the prefix, midfix, and suffix from a chemical name. The resulting string of chemical descriptors is compared against a database of chemical names and synonyms of chemical names for matches. The system allows users to identify particular chemicals in a database, as well as chemicals that are similar to the particular chemical.

### RELATED UNITED STATES APPLICATIONS/CLAIM OF PRIORITY

Not applicable.

### FIELD OF THE INVENTION

The present invention relates to a system and method of storing, searching, and retrieving the names of chemicals in a relational database quickly and efficiently.

### BACKGROUND OF THE INVENTION

The Internet has become an increasingly important platform for searching and exchanging chemical information through a variety of chemical information systems. The most common method of identifying a chemical for trade is its name. Defining a chemical using its name, however, has been a confounding problem in chemistry for many years. Although the International Union of Pure and Applied Chemistry (“IUPAC”) has tried to define a single set of rules for the naming of chemicals, common names specific to different regions of the world and different sections of the chemical industry persist in general use. If the Internet is to become a viable alternative to traditional methods of chemical information retrieval, there must be a method to unambiguously determine the name of the chemical under investigation.

Until recently, databases of chemical names traditionally have been developed using customized computer code because of the difficulty of describing the structure of chemicals in a standard relational database management system (“RDBMS”), such as the Oracle Relational Database Management System (“Oracle”) developed by Oracle Corporation, World Headquarters, 500 Oracle Pkwy., Redwood Shores, Calif. 94065. The advantages of using an RDBMS for storing and retrieving chemical names include: cost savings associated with using an off-the-shelf software package instead of developing a specialized software package; greater compatibility with other software applications; and greater compatibility between different databases.

In the prior art, there exists a method to store and retrieve a chemical name based on fragmenting each chemical name and applying a query to each fragment. For example, the U.S. Pat. No. 5,950,192 patent teaches the use of a method of chemical name searching by storing and indexing defined name fragments. The query itself is degenerated into its constituent chemical terms. The terms are sorted in ascending order by frequency of occurrence found by looking up the number of compounds having a particular term in a stored table. The search is then performed by running a correlated subquery. Thus, a database of 20,000 compounds would become at least 100,000 entries after fragmentation and would require the user to make at least two queries before the “correct” chemical is identified. Because of the number of fragments that must be searched, this method is suitable mostly for local computation and is not optimized for searching over low-bandwidth Internet systems.

### SUMMARY OF THE INVENTION

The present invention overcomes the aforementioned problems of the prior art by providing a more efficient solution. According to a first aspect of the present invention, a method for searching chemical names stored in a relational database of chemical names is provided. The present invention creates a database of chemicals that is searchable by a chemical's base name only. The base name of a chemical is defined as that portion of an IUPAC common chemical name that is remaining after all prefixes, midfixes (a midfix is any terminology in a chemical name that is located between the chemical descriptors of an IUPAC, Chemical Abstract Service (“CAS”), or common name), and suffixes have been removed. The user initiates a search by inputting a chemical name. The system manipulates the chemical name by removing all prefixes, midfixes, and suffixes from the chemical name. The resulting string of chemical descriptors is the base name of a chemical, and is used as a query by the system. The query is compared against the chemical names and synonyms of chemical names that are contained in the database. All chemical names and synonyms that contain the base name are presented to the user.

In a second aspect of the present invention, a computer-readable medium containing instructions for causing a processor to perform the method of searching chemical names described above is provided.

In a third aspect of the present invention, a system for searching chemical names stored in a relation database is provided. The system comprises means for performing the method described above.

In a fourth aspect of the present invention, a server for searching chemical names stored in a relational database comprising a table of chemical names and a table of chemical descriptors is provided. The server comprises memory containing said database and an associated program, and a processor responsive to said program. The processor is configured to perform the method described above.

In a fifth aspect of the present invention, a client machine for searching chemical names stored in a relational database comprising a table of chemical names and a table of chemical descriptors is provided. The client machine comprises memory containing a program and a processor responsive to said program. The processor is configured to send a chemical name to a server so that the server will manipulate the chemical name and construct a query that is compared to the database according to the method described above. The client machine further comprises a monitor to display the results of said query.

And in a sixth aspect of the present invention, a database of chemical names is provided. The database comprises a table of chemical descriptors, a table of chemical names, and computer code causing a processor to manipulate a chemical name and construct a query that is compared to the database to search for a chemical name.

The present invention will allow the user of an Internet-based chemical information system to search a database without actually needing to know the nomenclature of the desired chemical. An additional benefit of the present invention is that the user is presented the names of all chemicals containing the base name of the desired chemical. This provides the user with potential substitutes for the desired chemical. The present invention allows a user to actively find a chemical in a database without needing to know the manner in which that particular stereochemical, regiochemical, positional spacial or enantiomeric isomer is described. The present invention is particularly well-suited for use over the Internet because of its speed, ease of use, and portability between databases.

These and other aspects, features and advantages of the present invention will become better understood with regard to the following descriptions, claims, and accompanying drawings.

### BRIEF DESCRIPTION OF THE DRAWINGS

Referring briefly to the drawings, embodiments of the present invention will be described with reference to the accompanying drawings in which:

FIG. 1 depicts the hardware configuration of the present invention.

FIG. 2 depicts a flow chart that illustrates the steps related to the method or process of one aspect of the present invention.

### DETAILED DESCRIPTION OF THE INVENTION

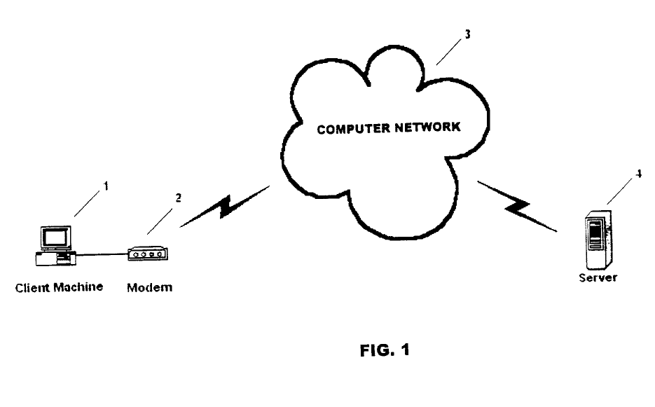

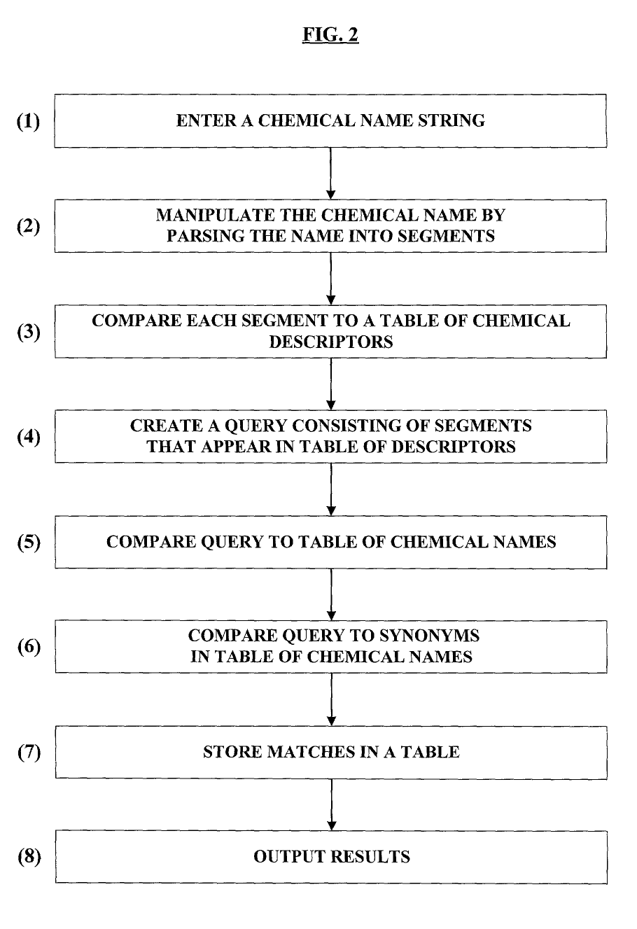

Referring more specifically to the drawings, for illustrative purposes the present invention is embodied in the system configuration, method of operation, and article of manufacture or product, such as a computer-readable medium, for example, a floppy disk, a conventional hard disk, CD-ROM, Flash ROM, nonvolatile ROM, RAM, and any other equivalent computer memory device, generally shown in FIGS. 1-2. It will be appreciated that the system, method of operation, and article of manufacture may vary as to the details of its configuration and operation without departing from the basic concepts disclosed herein. The following description is, therefore, not to be taken in a limiting sense.

The present invention makes use of standard relational database technology such as that found in the commercial product Oracle that is marketed by Oracle Corporation as noted above. All references to the retrieval and storage of information will be done in a standard relational database, and will use standard procedures for doing so, including structured query language (“SQL”) commands. When the term “query” is used as a noun, “query” means comparison criteria that are used to extract all the records matching the comparison criteria. When the term “query” is used as a verb, “query” means to extract records from a database that match specified comparison criteria. The operations and functions of relational databases discussed in this patent application are well known to those of ordinary skill in the database management field. Those operations and functions can be found in numerous texts, including Oracle users' and developers' manuals.

I. Hardware

Referring now to FIG. 1, one embodiment of the relational database management system for identifying the raw materials consumed in the manufacture of a chemical product is shown (the “system”). The user of the system will access the system through a client machine (e.g., a personal computer) (1) that is connected to a computer network (3), such as the Internet, via a modem (2) or other communications device. Presently, one embodiment of the client machine is a personal computer with a processor speed of at least 800 MHz, system memory of at least 64 MB, a monitor and keyboard, and running Internet Explorer, version 4.0 or later, or Netscape, version 4.0 or later. And of course, the present invention can be practiced on a computer that is slower, or has less memory, or a computer that is faster, or has greater capability, than the embodiment of the personal computer described above. A user can chemical name search requests to the system from a personal computer via a computer network (3). The system comprises a server (4), with its own computer processor and associated memory, and running relational database software. One embodiment of the computer network is a global TCP/IP based network such as the Internet or an intranet, although almost any well known LAN, MAN, WAN, or VPN technology can be used.

II. Relational Database Interface

As noted above, one of the advantages of using relational databases for a chemical name search is that there is no special interface for users because it uses C with embedded SQL. In one embodiment, the user will interface with the system via a web site over the Internet.

III. Database Structure

In one embodiment, the database structure comprises two tables: (i) a table of chemical names and (ii) a table of chemical descriptors. The table of chemical names comprises the following six (6) fields:

(1) ChemID;

(2) Chemical Name;

(3) Synonyms;

(4) Molecular Formula;

(5) CAS Number; and

(6) Chemical Descriptors.

The ChemID is a primary key that is unique for every chemical. Each time a chemical name is added to the database, it is assigned the next available ChemID number. The Chemical Name is the name of the chemical that may include a prefix, midfix, or suffix. The IUPAC has issued rules of systematic nomenclature for chemical structures. Under the IUPAC rules, however, a single chemical structure can be defined by more than one name. When this happens, one of the names will be used as the Chemical Name and the other name(s) will be used as a synonym(s). Synonyms are trade names by which the chemicals are recognized in different sections of the chemical industry and different regions of the world. The Molecular Formula is the molecular formula of the chemical. The CAS Number is the CAS Registry Number assigned to a chemical by the Chemical Abstracts Service of the American Chemical Society. CAS Registry Numbers are unique identifiers for chemical substances. While each CAS Number alone does not indicate any of the properties of a chemical, a CAS Number is an unambiguous identifier of a particular chemical substance. And the Chemical Descriptors are the chemical descriptors contained in a chemical name. Each chemical name includes one or more chemical descriptor. Chemical descriptors can be a functional group or a parent molecule. In addition, the database contains a separate table of every chemical descriptor defined by the IUPAC.

The database is stored on a computer-readable medium, such as a floppy disk, conventional hard disk, CD-ROM, Flash ROM, nonvolatile ROM, or nonvolatile RAM.

IV. Processing a Search for a Chemical Name

Chemical names are comprised of prefixes, midfixes, suffixes, and chemical descriptors that describe the chemical. Consider the chemical name “3-chloro-2-bromo benzoic acid, sodium salt” as an example. The prefix is “3-”; the midfix is “-2-”; and the suffix is “, sodium salt”. If the prefix, midfix, and suffix are removed, what remains is the base name of the chemical. For this example, the base name is “chloro bromo benzene.” This base name is composed of the chemical descriptors “chloro,” “bromo” and “benzene.” Searching for a particular chemical is very complex because of the fact that chemical names are composed of prefixes, midfixes, suffixes, and chemical descriptors. In a typical chemical name search system, if the name of a chemical is not entered correctly, the search will provide erroneous results. The present invention allows a user to search and find a chemical in a database without actually knowing the preferred nomenclature for naming the chemical.

Searches can be performed based on three different parameters: (1) Chemical Name; (2) Molecular Formula; and (3) CAS Number.

a. Chemical Name Search

As noted above, chemical name searching has been a problem of special note in the field of chemical information systems. Most chemical names are long and complex strings that are not easily searchable by standard substring searching mechanisms. This problem is compounded by the fact that most chemicals are known by many systemic or trade names.

Referring to FIG. 2, the process or flow chart for chemical name searching is illustrated. In one embodiment, searches will be performed remotely by a user on a personal computer connected to the Internet. As shown in FIG. 2, the initial step is to input a chemical name string on a web site that serves as an interface to the system. The chemical name search request is sent electronically to the system via the Internet.

As shown in block 2, when the system receives the chemical name search request, the chemical name is manipulated so that all prefixes, midfixes, and suffixes of the input are removed using standard SQL techniques. The system treats blank spaces and other special characters contained in the chemical name, such as the comma (“,”) dash (“-”), and brackets as truncating characters. In one embodiment, the system parses the chemical name into segments (where a segment is a string of characters that is separated by a truncating character). As shown in block 3, the system then compares each segment to the table of chemical descriptors. As shown in block 4, the system creates a query that is composed of a concatenated strings of the segments that match a chemical descriptor. All other strings of characters are assumed to be either a prefix, midfix, or suffix, and are deleted. The resulting query is a string of chemical descriptors, which is the base name of a chemical.

As shown in block 5, the query is compared against all of the chemical names in the database using standard relational database technology. A match is found when all of the chemical descriptors in a query match exactly or are contained within a chemical name. In one embodiment, the query is compared to the chemical descriptor field for each chemical name record. The order in which the chemical descriptors appear in a chemical name does not matter. For example in the chemical name “3-chloro-2-bromo benzene”, the chemical descriptors are “chloro,” “bromo” and “benzene.” Any chemical name, containing the chemical descriptors “chloro,” “bromo” and benzene” would be considered a match regardless of the order in which the chemical descriptors appear in the chemical name. As shown in block 6, after the query is compared to all chemical names, it is compared to all synonyms in the database using standard database technology. A match is found when all of the chemical descriptors in a query match exactly or are contained in a synonym, regardless of the order in which the chemical descriptors appear in the synonym. The step of comparing queries against synonyms is very important because of the fact that chemical names vary by industry and region of the world. As shown in block 7, matches are stored in the a table of matches.

As shown in block 8, in one embodiment the results are outputted to the user in the form of a table, where results are defined as all chemical names and synonyms contained in the table of matches. For example, when the string “zinc” is sent to the system, the system reports over 35 instances of “zinc” appearing in a chemical name or synonym. These results are shown to the user in order of relevance, where relevance is closeness of match between the query and the chemical name or synonym. The user is presented a listing of all matches. For each match, the results also provide the user with the CAS Number and Molecular Formula of the chemical.

b. Molecular Formula Searching

Molecular formula searching can be done by using standard SQL string search methods on all or part of the formula. Key searching (lookup by identifier) is a standard SQL operation.

c. CAS Number Searching

CAS Number searching can be done by using standard SQL string search methods on all or part of the CAS Number. Key searching (lookup by identifier) is a standard SQL operation.

Having now described one embodiment of the invention, it should be apparent to those skilled in the art that the foregoing is illustrative only and not limiting, having been presented by way of example only. All the features disclosed in this specification (including any accompanying claims, abstract, and drawings) may be replaced by alternative features serving the same purpose, and equivalents or similar purpose, unless expressly stated otherwise. Therefore, numerous other embodiments of the modifications thereof are contemplated as falling within the scope of the present invention as defined by the appended claims and equivalents thereto.

Moreover, the techniques may be implemented in hardware or software, or a combination of the two. Preferably, the techniques are implemented in control programs executing on programmable devices that each include a processor, a storage medium readable by the processor (including volatile and non-volatile memory and/or storage elements), at least one input device and one or more output devices. Program code is applied to data entered using the input device to perform the functions described and to generate output information. The output information is applied to one or more output devices.

Each program is preferably implemented in a high level procedural or object oriented programming language to communicate with a computer system, however, the programs can be implemented in assembly or machine language, if desired.

Each such computer program is preferably stored on a storage medium or device (e.g., CD-ROM, hard disk or magnetic diskette) that is readable by a general or special purpose programmable computer for configuring and operating the computer when the storage medium or device is read by the computer to perform the procedures described in this document. The system may also be considered to be implemented as a computer-readable storage medium, configured with a computer program, where the storage medium so configured causes a computer to operate in a specific and predefined manner.

What is claimed is:

1. A method for searching chemical names, stored in a relational database comprising a table of chemical names and a table of chemical descriptors, comprising:
receiving a chemical name;
parsing said chemical name into segments;
comparing each said segment to records in said table of chemical descriptors;
constructing a query that consists of a concatenated string of said segments that occur in said table of chemical descriptors; and
comparing said query to records in said table of chemical names, wherein a match is found when each segment of said query is contained in a chemical name or in a synonym in said table of chemical names.

2. The method of searching chemical names stored in a relation database of claim 1, further comprising storing said matches of chemical names and synonyms in a table of matches in said relational database.

3. The method of searching chemical names stored in a relation database of claim 2, further comprising outputting said matches stored in said table of matches.

4. A computer-readable medium containing instructions for causing a processor to perform a method of searching chemical names stored in a relational database comprising a table of chemical names and a table of chemical descriptors, the method comprising:
receiving a chemical name;
parsing said chemical name into segments;
comparing each said segment to records in said table of chemical descriptors;
constructing a query that consists of a concatenated string of said segments that occur in said table of chemical descriptors; and
comparing said query to records in said table of chemical names, wherein a match is found when each segment of said query is contained in a chemical name or in a synonym in said table of chemical names.

5. The computer-readable medium containing instructions for causing a processor to perform a method of searching chemical names stored in a relational database comprising a table of chemical names and a table of chemical descriptors of claim 4, wherein said method further comprises storing said matches of chemical names and synonyms in a table of matches in said relational database.

6. The computer-readable medium containing instructions for causing a processor to perform a method of searching chemical names stored in a relational database comprising a table of chemical names and a table of chemical descriptors of claim 5, wherein said method further comprises outputting said matches stored in said table of matches.

7. A system for searching chemical names, stored in a relational database comprising a table of chemical names and a table of chemical descriptors, comprising:
means for receiving a chemical name;
means for parsing said chemical name into segments;
means for comparing each said segment to records in said table of chemical descriptors;
means for constructing a query that consists of a concatenated string of said segments that occur in said table of chemical descriptors; and
means for comparing said query to records in said table of chemical names, wherein a match is found when each segment of said query is contained in a chemical name or in a synonym in said table of chemical names.

8. The system for searching chemical names stored in a relational database comprising a table of chemical names and a table of chemical descriptors of claim 7, further comprising means for storing said matches of chemical names and synonyms in a table of matches in said relational database.

9. The system for searching chemical names stored in a relational database comprising a table of chemical names and a table of chemical descriptors of claim 8, further comprising means for outputting said matches stored in said table of matches.

10. An apparatus for searching chemical names, stored in a relational database comprising a table of chemical names and a table of chemical descriptors, comprising:
memory containing said database and an associated program; and
a processor responsive to said program and configured to: (i) receive a chemical name; (ii) parse said chemical name into segments; (iii)compare each said segment to records in said table of chemical descriptors; (iv) construct a query that consists of a concatenated string of said segments that occur in said table of chemical descriptors; and (v) compare said query to records in said table of chemical names, wherein a match is found when each segment of said query is contained in a chemical name or in a synonym in said table of chemical names.

11. The apparatus for searching chemical names stored in a relational database comprising a table of chemical names and a table of chemical descriptors of claim 10, wherein said processor is further configured to store said matches of chemical names and synonyms in a table of matches in said relational database.

12. The apparatus for searching chemical names stored in a relational database comprising a table of chemical names and a table of chemical descriptors of claim 11, wherein said processor is further configured to output said matches stored in said table of matches to a remote user.

13. An apparatus for searching chemical names stored in a relational database comprising a table of chemical names and a table of chemical descriptors, comprising:
memory containing a program;
a processor responsive to said program and configured to send a chemical name to a server so that the server will: (i) parse said chemical name into segments; (ii)compare each said segment to records in said table of chemical descriptors; (iii) construct a query that consists of a concatenated string of said segments that occur in said table of chemical descriptors; (iv) compare said query to records in said table of chemical names, wherein a match is found when each segment of said query is contained in a chemical name or in a synonym in said table of chemical names; (v) store said matches of chemical names and synonyms in a table of matches in said relational database; and (vi) output said matches stored in said table of matches to said apparatus; and
a monitor to display said output.

14. The apparatus for searching chemical names stored in a relational database comprising a table of chemical names and a table of chemical descriptors of claim 13, wherein said program is an internet browser program.

15. A database of chemical names comprising:
a table of chemical descriptors;
a table of chemical names comprising the following fields: (i) chemical name; (ii) the primary key for each said chemical name; and (iii) synonyms of each said chemical name; and
computer code containing instructions to cause a processor to (i) receive a chemical name; (ii) parse said chemical name into segments; (iii)compare each said segment to records in said table of chemical descriptors; (iv) construct a query that consists of a concatenated string of said segments that occur in said table of chemical descriptors; and (v) compare said query to records in said table of chemical names, wherein a match is found when each segment of said query is contained in a chemical name or in a synonym in said table of chemical names.

16. The database of chemical names of claim 15, wherein said computer code further contains instructions to cause said processor to store said matches of chemical names and synonyms in a table of matches in said database.
